(19) United States
(12) Patent Application Publication
(10) Pub. No.: US 2022/0383652 A1
(43) Pub. Date: Dec. 1, 2022

(54) Monitoring Animal Pose Dynamics from Monocular Images

(71) Applicant: Google LLC, Mountain View, CA (US)

(72) Inventors: Bryan Andrew Seybold, San Francisco, CA (US); Shan Yang, Sunnyvale, CA (US); Bo Hu, Sunnyvale, CA (US); Kevin Patrick Murphy, Palo Alto, CA (US); David Alexander Ross, San Jose, CA (US)

(21) Appl. No.: 17/775,529

(22) PCT Filed: Nov. 4, 2020
(86) PCT No.: PCT/US2020/058882

§ 371 Date: May 9, 2022

Related U.S. Application Data
(60) Provisional application No. 62/932,007, filed on Nov. 7, 2019.

(51) Int. Cl. G06V 40/10; G06V 40/20; G06V 10/82; G06V 10/62; A01K 29/00

(52) U.S. Cl. CPC G06V 40/10; G06V 40/25; G06V 10/82; G06V 10/62; A01K 29/005

(57) ABSTRACT

A computing system comprising one or more computing devices can obtain one or more images of an animal. The computing system can determine, using at least one of one or more machine-learned models, a plurality of joint positions associated with the animal based on the one or more images. The computing system can determine a body model for the animal. The computing system can estimate a body pose for the animal based on the one or more images, the plurality of joint positions, and the determined body model.

### RELATED APPLICATIONS

This application claims priority to and the benefit of U.S. Provisional Patent Application No. 62/932,007, filed Nov. 7, 2019, which is hereby incorporated by reference in its entirety.

### FIELD

The present disclosure relates generally to computer image processing. More particularly, the present disclosure relates to processing images of animals to measure the pose of those animals.

### BACKGROUND

In various situations it may be desirable to understand or measure the pose of an animal. However, measuring animal pose may require handling the animal. This requires human operator time and, for certain animals, can be stressful to the animals.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for determining poses of animals from imagery. The method includes obtaining, by a computing system, one or more images of an animal. The method includes determining, by the computing system and using at least one of one or more machine-learned models, a plurality of joint positions associated with the animal based on the one or more images. The method includes determining, by the computing system, a body model for the animal. The method includes estimating, by the computing system, a body pose for the animal based on the one or more images, the plurality of joint positions, and the determined body model.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example computing environment according to example embodiments of the present disclosure.

FIG. 2 depicts an example computing environment according to example embodiments of the present disclosure.

FIG. 3 depicts a block diagram of an animal diagnostic model according to example embodiments of the present disclosure.

FIG. 4A depicts an image of an animal (e.g., a rat) captured by an image capture system according to example embodiments of the present disclosure.

FIG. 4B depicts an image of an animal (e.g., a rat) that has been analyzed to identify a plurality of joint positions according to example embodiments of the present disclosure.

FIG. 4C depicts an image of an animal (e.g., a rat) according to example embodiments.

FIG. 4D depicts an example three-dimensional body model according to example embodiments.

FIG. 5 depicts a block diagram of an animal monitoring system according to example embodiments of the present disclosure.

FIG. 6 depicts a block diagram of a multi-step model for generating diagnoses for animals according to example embodiments of the present disclosure.

FIG. 7 depicts a flow chart of an example method for monitoring animals using image data according to example embodiments of the present disclosure.

### DETAILED DESCRIPTION

The present disclosure is directed towards systems and methods for automatically monitoring animal pose. Specifically, one example system can use one or more images captured by one or more cameras to determine one or more poses associated with an animal (such as a mouse, rat, or other rodent). The pose data associated with a particular animal can be evaluated to determine whether the animal is exhibiting behavior outside the established norm. In particular, in one example process, camera images can be input into a machine-learned model to identify a plurality of joint positions for the animal. These joint positions can be combined with a body model to predict a pose for the animal. A series of poses over time can be analyzed to estimate motion for the animal. The estimated motion can be analyzed to diagnose one or more problems with the animal. Using captured image data in this fashion can enable monitoring of animal behavior and pose without the need to handle or otherwise interfere with the animal in ways that might cause undue stress to the animal.

More specifically, in various situations it may be important to be able to monitor the behavior of animals as efficiently as possible. Efficient monitoring can result in more timely interventions if problems arise. For example, if an animal in a becomes sick or injured, a timely notification can allow an individual to intervene.

One method for monitoring animals is using one or more cameras to capture image data of the animal. Digital cameras can be a reliable way to regularly capture image data from a plurality of animals. For example, a single camera can monitor multiple animals if the camera device has high enough resolution. Thus, one or more cameras can be used to cost-efficiently monitor multiple animals at once. In another example, two or more cameras can be used to capture images of animals from more than one angle. Using cameras to generate image data of one of the one or more animals allows the animals to be monitored without having to physically be handled by persons. Avoiding the handling of animals can avoid placing undue stress on the animals.

Once image data has been captured for the animals (e.g., a rat or mouse), a pose estimation system can be employed to generate an estimated pose for the animal. An estimated pose can comprise a digital three-dimensional model reconstruction of the animal with its limbs and body in the same position as the limbs and body of the animal that is depicted in the image data. The camera can capture multiple images of the particular animal over a period of time. Each image can be processed to provide an estimated pose for the animal at that time.

Once the animal monitoring system has generated multiple estimated model poses for the animal, an animal diagnostic model can be used to determine the movement or other behaviors or characteristics of the animal during that period of time. The movement of the animal can be used to determine whether or not the animal is exhibiting any unusual or abnormal behaviors (e.g., gait). For example, an animal may have been limping, the animal may have been moving more or less than is expected, or the animal may have difficulty breathing.

Thus, an animal monitoring system can include an image capture system, a computing system, and an animal body database. In some examples, the image capture system is connected to the computing system via one or more networks. The image capture system can include any device capable of capturing visual data and storing it for access by the computing system. For example, the image capture system can comprise any device that includes a digital camera such as a web camera, a smartphone, a surveillance camera, a laptop with a built-in camera, and so on.

The digital images may be stored in one of a plurality of different file formats including but not limited to image file formats (e.g., JPEGs, TIFFs, GIFs, PNGs, and so on), video file formats (AVIs, FLVs, WMV, MOV, MP4 and so on), as well as any of a plurality of other digital file formats. The image capture device can store the image data in a local storage device or transmit it directly to the computing system.

In some examples, the computing system includes one or more processors, a memory device storing both data and instructions, an animal monitoring system, and an animal body database. In some examples, the animal monitoring system can enable the computing system to take images of an animal as input and produce a diagnosis of an animal's condition as output. The animal monitoring system can also produce other outputs as needed. The animal body database can be accessed by the animal monitoring system to determine, based on image data, whether or not the animal is healthy. The animal body database can be used both in training a computer-learned model included in the animal monitoring system (e.g., an animal diagnostic model) and, once the model is trained, to accurately estimate the animal's current pose based on the image data.

For example, in training the animal diagnostic model to identify one or more joint positions of an animal in the image based on a two-dimensional image, the animal monitoring system can employ data stored in the animal body database. In some examples, rather than use a large number of images of the animal in all settings to train the animal diagnostic model, the animal monitoring system can focus only on images of animals in various settings. This can reduce the number of images that are needed to train the model and reduce the time needed to accurately label the training data.

In addition, the animal monitoring system can select an animal body model based on a two-dimensional image. In some examples, the selection of the animal body model can be performed by a machine-learned model that has been trained to do so. In other examples, an optimizer can perform this selection as part of the process of identifying the correct body pose for the animal. In some examples, an animal body model can represent the size and shape of an animal. Thus, to correctly model an animal in an image, the animal monitoring system can select an animal body model that closely resembles the animal in the image data. For example, some rats may be larger than others. As such, a body model that closely resembles the body of the actual rat should be selected to increase the probability of correctly identifying the pose of the rat. Similarly, one animal may be thinner or heavier than another of the same size. As a result, the animal monitoring system can select a body model based on size, length, and weight to ensure that the selected body model matches the animal depicted in the image data as closely as possible.

The animal body database can include information about animal poses and about animal body shapes and/or animal body models. For example, the animal body model can be manipulated into poses that it is unlikely that an animal would exhibit. Pose data in the animal body database can be used to ensure that the body model is manipulated such that unlikely poses will not be selected as the estimated body pose unless no other poses are viable. This can be accomplished in a plurality of ways including, initially limiting the number of adjustable points or pivot points that can be manipulated on a body model. Instead, the body model can initially be adjusted in general position and orientation factors to reach a likely coarse positioning of the body model. Each successive round of adjustments can enable more points to be adjusted until an estimated pose is identified. Adjustments continue until the body and pose model best match the image data and a plurality of other constraints such as the number of adjustable points.

The animal monitoring system can include one or more components, each component performing a specific action within the animal monitoring system. For example, the animal monitoring system can include a pose determination system and a movement analysis system. In some examples, the pose determination system and movement analysis systems can be machine-learned models that are sub-models within a larger animal diagnostic model. The pose determination system can receive as input an image of an animal. The pose determination system can determine based on the image one or more joint positions for the particular animal. A joint position is a place along which the animal's body can flex or be manipulated. For example, joint positions may represent any joint of the animal's body which may move, such as an elbow, knee, or neck. In some examples, the joint positions can be used to estimate the two-dimensional pose.

In some examples, the pose determination system can be trained to identify the joints for a particular animal. For example, the pose determination system may be trained to identify the joint positions of a mouse or rat. In other examples, the pose determination system may be trained to identify the joint positions of multiple different animals. In this case, the pose determination system may first determine the specific species of animal in the image.

Once the pose determination system has identified one or more joint positions (and potentially an estimated two-dimensional pose or other derived data), the pose determination system can select a body model (e.g., a body representation) that matches the received joint positions. For example, the pose determination system can select a body model based on the estimated height, girth, or length of the animal depicted in the image. In some examples, other measurements of the body of the animal in the image can be used to select an appropriate body model. In some examples, the animal body database can include a plurality of potential body models for each species. The pose determination system can select the appropriate model based on the joint position data and the received image data. In some implementations, a neutral body shape can be selected and the shape can be refined during subsequent steps.

Once the body model is selected, the pose determination system can adjust the selected body model to match the pose in the image. For example, the pose determination system includes an optimizer that can make a series of pose alterations to the body model, each alteration involving manipulating one or more of the joints to move the limbs and body of the animal into a different pose. In some examples, as noted above, the set of joints that can be manipulated (e.g., the set can begin with a small number of limited joints (or other manipulation points) and can gradually be increased over time). The pose determination system can access animal pose data from the animal body database. This pose data can be used to evaluate which adjustments are most likely and thus increase the efficiency of the animal diagnostic model.

In some examples, the pose determination system can be used to generate a plurality of poses for each image in a plurality of images, wherein the images are captured over a period of time. The series of estimated poses can be transmitted to be used as input to the movement analysis system. The movement analysis system can analyze a series of pose estimates, each pose estimate representing the pose of an animal at a particular period of time, to estimate the movement of the animal during that period of time.

In some examples, the movement analysis system can generate an internal model of the animal's movement. That internal movement model can be analyzed to determine whether the animal's movement is within the normally expected movement for the animal. If the animal's movement is within the normally expected movement for the animal, the movement analysis system can report the animal seems to be healthy. However, if the movement is determined to be outside of the normally expected move from the animal (e.g., the animal's movement is abnormal), the movement analysis system can generate a diagnosis for the animal.

Examples of abnormal movement can include limping, lower overall movement, difficulty breathing, hyperactivity, aggression, and/or any other movement that is outside the bounds of typical animal movement. In some examples, the movement analysis system can be trained with a sufficient amount of animal movement data such that it can determine normally expected animal movements from abnormal movements. For example, the movement analysis system can determine one or more gaits that are commonly observed in healthy animals and thus determine when an animal's gait has fallen outside the normal range.

Once abnormal movement is detected, the movement analysis system can generate a diagnosis for the animal. For example, if the animal is limping, the movement analysis system can generate a diagnosis indicating an injury to the animal's leg. In some examples, any diagnoses can be transmitted to an owner, a system administrator, or other person overseeing the animals.

In some examples, the animal diagnostic system receives image data from the image capture system. The image data can then be used as input to a joint identification model. As noted above, the identification model uses image data to identify one or more joint positions for an animal depicted in the image data. Once the joint positions have been identified, the joint position data can be transmitted to the body selection model. As noted above, the body selection model determines the specific model body to be used when modeling the subject of the image data.

The image data, body model, joint data and any other features derived from the image data can be transmitted to a pose evaluator. Other features can include, but are not limited to, body outline data or image segmentation data. The pose evaluator can include a model manipulator and a loss calculator. The model manipulator can set the received body model in a neutral position. A neutral position may be a predetermined base position for which the animal body model can be manipulated. The model manipulator can then begin a process of adjusting one or more pivot points on the model body from the neutral position to a position that more closely matches the pose of the animal in the depicted image data. In some examples, this process begins with a series of rough-tuning adjustments including, but not limited to, changing the position and angle of the body to move it roughly into the same position and angle of the target animal.

Once the rough-tuning has been accomplished, the model manipulator can begin making fine-tuning adjustments in a series of adjustment rounds. In some examples, each adjustment round enables additional pivot points to be enabled for manipulation. In this way, the pose evaluator attempts to identify a correct pose for the model body without selecting a pose that superficially seems the same but is incorrect (e.g., a local minimum).

The pose evaluator can access a loss calculator to determine, for each step in the manipulation process, whether or not the most recent adjustment moves the model body to be closer to the target pose rather than farther from the target pose. The loss calculator can calculate a loss value to represent the difference between the currently estimated pose and the actual pose depicted in the image.

In some examples, the loss value can include one or more components, each of which contribute to the overall loss value. For example, the loss value can include a joint position similarity score, a silhouette similarity score, and a reference comparison score. A joint position similarity score can include calculation of the difference between the determined positions of the joints in a two-dimensional projection of the current body pose and the one or more joint positions determined from the original image.

The loss calculator can determine a difference value for each joint position in the projected two-dimensional image and the actual original image. The differences can then be summed to generate a joint position similarity score. Similarly, a silhouette similarity score can represent the difference between the silhouette of the original image and the silhouette of a two-dimensional projection of the current body pose. The silhouette similarity score and the joint position similarity score can be added together to determine a loss value for a current body pose. In some examples, the joint position similarity score and the silhouette similarity score can be weighted such that the score that is weighted more heavily contributes more to the overall loss value. In some examples, the weight assigned to each score can be determined based on the species of animal being monitored.

In some examples, after each manipulation of the current body model, the model manipulator can access the loss calculator to determine whether the last value has increased or decreased. In response to determining that the loss value has decreased, the model manipulator can retain the previous adjustment. In accordance with the determination that the loss value has increased, the model manipulator can discard the previous manipulation and select a new manipulation.

A reference comparison score can be generated based on pose data included in the animal body database. For example, using pose information stored in the animal body database the pose evaluator can generate a reference comparison score that represents the degree to which the pose seems likely to occur. Thus, if a pose is not common in the reference data, it may receive a lower reference comparison score than another more common pose. In this way, the pose evaluator can prefer more likely poses over less likely poses.

The pose evaluator can continue to manipulate the model until an end state is reached. In some examples, the end state is reached when the loss value drops below a predetermined threshold. In other examples, the end state can be reached when the model manipulator has made a predetermined number of manipulations without finding any adjustments that improve the loss value. For example, if the model manipulator has performed fifty fine-tuning adjustments, all of which result in a worse loss value, the pose evaluator can determine that an end state has been reached.

The pose evaluator can select manipulations of the model that are more likely to result in a decreased loss value. In some examples, the pose evaluator (or an optimizer that is included in the pose evaluator) can generate gradient information (a mathematical evaluation of how different manipulations will affect the loss value). Using this gradient information, the pose evaluator can select a manipulation that will most efficiently lower the loss value.

In some examples, the pose evaluator can be part of an optimization system that enables highly specific pose estimations to be achieved. The estimated pose can be sent to the movement detector. The movement detector may receive a series of poses for the animal as it moves over time. Using a plurality of pose estimates the movement detector can determine the movement of the animal. The diagnostic module can take the estimated movement as input. Once the estimated movement has been input, the diagnostic module can determine a diagnosis for the animal.

In some examples, the process begins with an image of an animal. For example, the image may be of a mouse. The image can be analyzed to determine one or more joint positions. For example, the system can use a model that has been trained to identify joint positions for animals based on images. The system can generate a model for the mouse with a plurality of joints denoted including one or more relationships between different joint positions.

An animal monitoring system can include an animal diagnostic model. The animal diagnostic model can be trained to receive a set of input data (e.g. one or more images) associated with an animal, and, in response to the receiving input data, provide output data associated with the animals, including but not limited to an evaluation of the health of the animal, information about the animals activities, and/or animal position or pose data. Thus, in some implementations, the animal diagnostic model can be operable to provide an evaluation of the health of an animal using a series of images of the animal.

In some examples, the animal diagnostic model can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

The animal diagnostic model can be trained based on training data using various training or learning techniques, such as, for example, backward propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over several training iterations. In some implementations, performing backward propagation of errors can include performing truncated backpropagation through time. Generalization techniques (e.g., weight decays, dropouts, etc.) can be performed to improve the generalization capability of the models being trained.

The animal diagnosis model may be a multi-step model for generating a diagnosis of animals based on image data according to example embodiments of the present disclosure. The animal diagnosis model can include a pose determination model and a diagnosis model. The pose determination model can produce an estimated pose for an animal based on each of one or more input images. The diagnosis model can generate a diagnosis based on one or more estimated poses generated by the pose determination model.

The systems and methods described herein provide a number of technical effects and benefits. More particularly, the systems and methods of the present disclosure provide improved techniques for monitoring animals for abnormal behavior and generating diagnoses for those animals without the need to handle the animals using a machine-learned animal diagnosis model. For instance, the machine-learned animal diagnosis model (and its associated processes) allow various persons to effectively and efficiently monitor a plurality of animals automatically. This reduces the cost and time needed to monitor the health of the animals. In addition, using images to monitor health reduces the stress the animals undergo when handled by persons. The reduction of stress and the improvement in effective monitoring can be conducive for healthy animals. In addition, the information provided by the machine-learned animal diagnosis model can improve the accuracy of animal monitoring. As such, the disclosed system can significantly reduce the cost and time needed to effectively monitor animals and can result in improved experimental outcomes/accuracy.

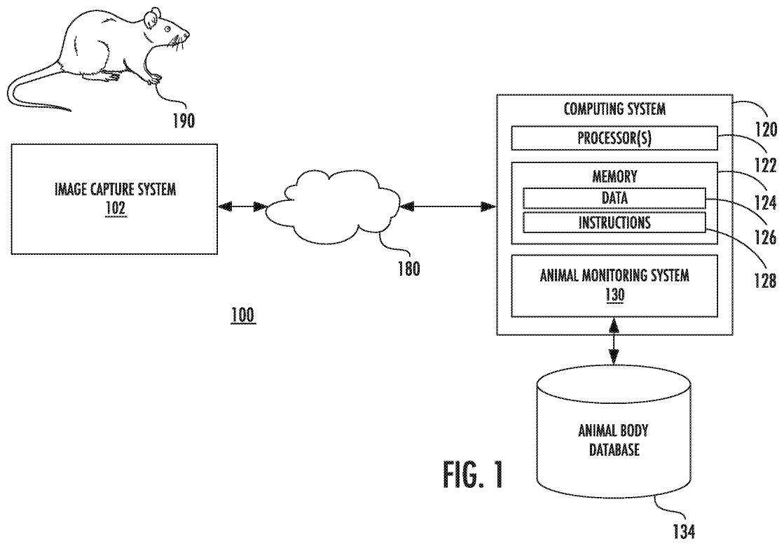

FIG. 1 depicts an example computing environment according to example embodiments of the present disclosure. Specifically, FIG. 1 depicts an animal monitoring system 100 that includes an image capture system 102 a computing system 120, and an animal body database 134. In some examples, the image capture system is connected to the computing system via one or more networks 180. The computing system 120 can be any type of computing or electronic device such as a personal computer, a server computer, a mainframe computer, smartphone, tablet, and so on. The image capture system 102 can include any device capable of capturing visual data and storing it for access by the computing system 120. For example, the image capture system 120 can comprise any device that includes a digital camera such as a web camera, a smartphone, a surveillance camera, a laptop with a built-in camera and so on.

The image capture system 102 can capture digital images of one or more animals 190. The digital images may be stored in one of a plurality of different file formats including but not limited to image file formats (e.g., JPEGs, TIFFs, GIFs, PNGs, and so on), video file formats (AVIs, FLVs, WMV, MOV, MP4 and so on), as well as any of a plurality of other digital file formats. The image capture system 102 can store the image data in a local storage device or transmit it directly to the computing system 120.

In some examples, the computing system 102 includes one or more processors 122, memory 124 storing both data 126 and instructions 128, an animal monitoring system 130, and an animal body database 134. The animal monitoring system 130 can enable the computing system 120 to take images of an animal as input and produce information about the animal (e.g., a diagnosis of an animal's health condition, the animal's location, movement history, and so on) as output. The animal body database 134 can be accessed by the animal monitoring system 130 to determine, based on image data, a variety of information about the animal. The animal body database 134 can include data that is used both in training one or more machine-learned models included in the animal monitoring system 130 and, once the one or more models are trained, to improve the accuracy of an estimated pose for the animal based on the image data.

For example, in training the one or more machine-learned models included in the animal monitoring system 130 to identify one or more joint positions of an animal based on a two-dimensional image, the computing system 120 can employ training data stored in the animal body database 134. In some examples, rather than use a large number of images of the animal in all settings to train the animal monitoring system 130, the computing system 120 can focus only on images of animals in various settings. This can reduce the number of images that are needed to train the model and reduce the time needed to accurately label the training data.

In addition, the computing system 120 can train the animal monitoring system 130 to select an animal body model based on a two-dimensional image. In some examples, the selection of the animal body model can be performed by a machine-learned model that has been trained to do so. In other examples, an optimizer can perform this selection as part of the process of identifying the correct body pose for the animal. In some examples, an animal body model can represent the basic size and shape of an animal. As a result, the animal monitoring system 130 can be trained to select for size length and weight to ensure that the selected body model matches the animal depicted in the image data as closely as possible.

In addition, the animal body database 134 can include information about animal poses. For example, the animal body model can be manipulated into poses that it is unlikely that an animal would exhibit. Pose data in the animal body database 134 can be used to ensure that the body model is manipulated such that unlikely poses will not be selected as the estimated body pose unless no other poses are viable. This can be accomplished in a plurality of ways including, initially limiting the number of adjustable points or pivot points that can be manipulated on a body model. Instead, initial manipulations of the body model can initially focus on adjusting the general position and orientation of the body model. Each successive round of adjustments can enable more points to be adjusted until an estimated pose is identified. Adjustments continue until the body and pose model best match the image data and a plurality of other constraints such as the number of adjustable points.

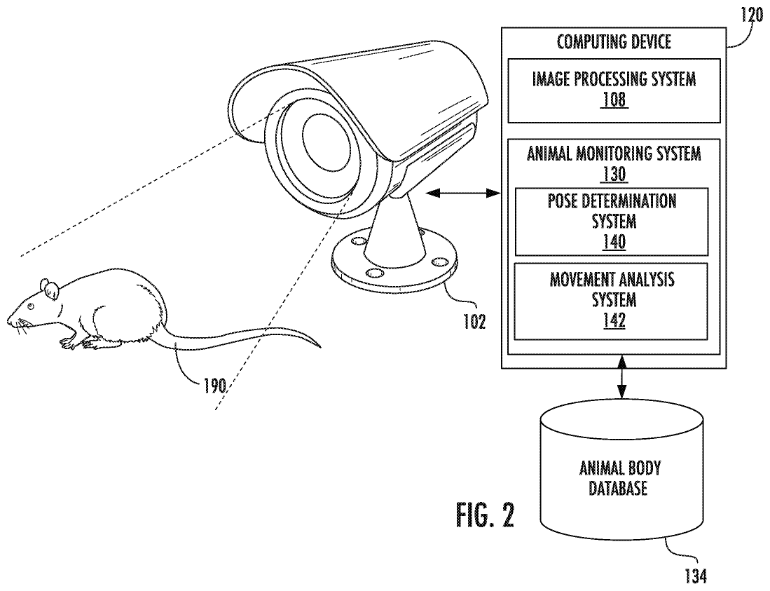

FIG. 2 depicts an example computing environment according to example embodiments of the present disclosure. Specifically, FIG. 2 depicts an animal monitoring system 200 that includes an image capture system 102, a computing system 120, and an animal 190 to be photographed. The computing system 120 can be a personal electronic device such as a smartphone, tablet, and so on. The image capture system 102 can include any device capable of capturing visual data and storing it for access by the computing system 120.

The computing system 120 includes an image processing system 108 and an animal monitoring system 130. The image processing system 108 can collect, standardize, and store image data captured by the image capture system 102.

The animal monitoring system 130 can include one or more components, each component performing a specific action within the animal diagnostic model. For example, the animal monitoring system 130 can include a pose determination system 140 and a movement analysis system 142. In some examples, the pose determination system 140 and movement analysis systems 142 can be sub-models within the larger animal monitoring system 130. The pose determination system 140 can receive as input an image of an animal. The pose determination system 140 can determine based on the image one or more joint positions for the particular animal. A joint position is a place along which the animal's body can flex or be manipulated. For example, joint positions may represent any joint of the animal's body which may move, such as an elbow, knee, or neck. In some examples, the joint positions can be used to determine a two-dimensional pose estimation.

In some examples, the pose determination system 140 can be trained to identify the joints for a particular animal. For example, the pose determination system 140 may be trained to identify the joint positions of a mouse or rat. In other examples, the pose determination system 140 may be trained to identify the joint positions of multiple different animals. In this case, the pose determination system 140 may first determine the specific species of animal in the image.

Once the pose determination system 140 has identified one or more joint positions, the pose determination system 140 can begin estimating a three-dimensional pose that matches the pose in the image data. In some examples, the pose determination system 140 can begin with a predetermined neutral pose and a predetermined neutral body model. An optimization algorithm can make a series of adjustments, both to the body model itself and the pose of the body model. Adjustments to the body model can include altering the size, shape, length, or other attribute of the body model.

Adjustments to the pose can comprise making a series of pose alterations to the body model, each alteration involving manipulating one or more of the joints to move the limbs and body of the animal into a different pose. In some examples, as noted above, the set of joints that can be manipulated is initially limited to a small number of joints (or other manipulatable points of the model) and can gradually be increased to include additional joints over time. The pose determination system 140 can access animal pose data, the animal pose data being received from the animal body database (e.g., database 134 in FIG. 1). This pose data can be used to evaluate which adjustments are most likely and thus increase the efficiency of the animal monitoring system 130.

In this way, the pose determination system 140 can execute an optimization algorithm that involves making a series of adjustments to the body model itself and the pose of the body model to arrive at a body model and estimated body pose that match the body model and pose of the animal depicted in the image.

In some examples, the pose determination system 140 can select an estimated body model (e.g., a body representation) that matches the received joint positions and use it as the initial body model that can be adjusted. For example, the pose determination system 140 can select a body model based on the height, girth, or length of the animal in the image. In some examples, other measurements of the body of the animal in the image can be used to select an appropriate body model. In some examples, the animal body database 134 can include a plurality of potential body models for each species. The pose determination system 140 can select the appropriate model based on the joint position data and the received image data.

In some examples, the pose determination system 140 can be used to generate a plurality of poses for each image in a plurality of images, wherein the images are captured over a period of time. The series of estimated poses can be transmitted to be used as input to the movement analysis system 142. The movement analysis system 142 can analyze a series of pose estimates, each pose estimate representing the pose of an animal at a particular period of time, to estimate the movement of the animal during that period of time.

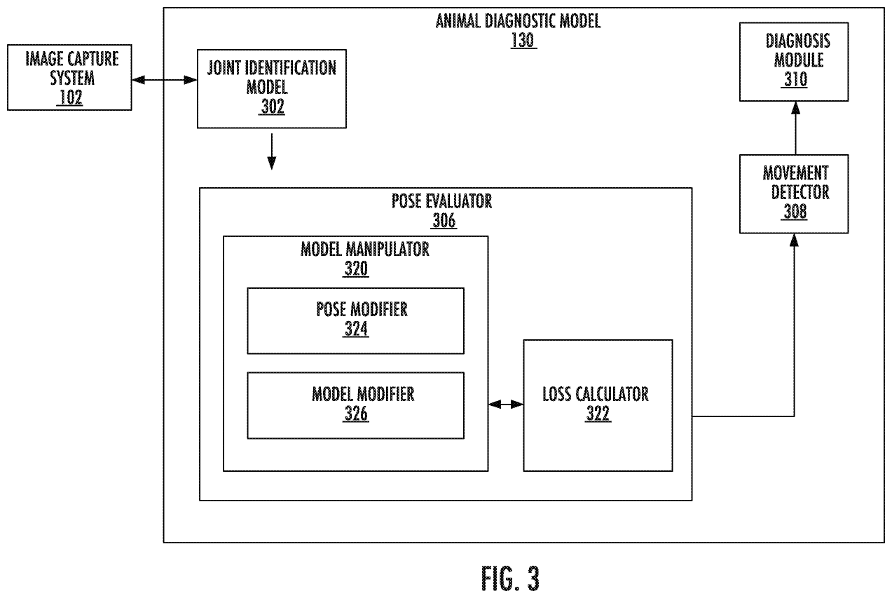

FIG. 3 depicts a block diagram of an animal diagnostic model according to example embodiments of the present disclosure. Specifically, FIG. 3 depicts an animal monitoring system 130 that includes a joint identification model 302, a body model selection model, a pose evaluator 306, a movement detector 308, and a diagnosis model 310.

In some examples, the animal monitoring system 130 receives image data from the image capture system 102. The image data can then be used as input to a joint identification model 302. As noted above, the joint identification model 302 can use image data to identify one or more joint positions for an animal depicted in the image data. Once the joint positions have been identified, the joint position data can be transmitted to a pose evaluator 306.

The pose evaluator 306 can include a model manipulator 320 and a loss calculator 322. The model manipulator 320 can include a pose modifier 324 and a shape modifier 326. The model manipulator can begin with a neutral body model (or an estimated body model) and set the body model in a predetermined neutral position. The shape modifier 326 can adjust one or more characteristics of the body model (e.g., shape, size, attributes, and so on) and simultaneously the pose modifier 324 can begin the process of adjusting one or more pivot points on the model body from the neutral position to a position that more closely matches the pose of the animal in the depicted image data. In this way, the pose evaluator 306 attempts to identify a correct pose and model body for the animal in the image data without selecting a pose that superficially seems the same but actually does not represent the actual pose of the animal (e.g., a local minimum).

The pose evaluator 306 can access a loss calculator 322 to determine, for each step in the manipulation process, whether or not the most recent adjustments to the model body and pose moves the estimated pose to be closer to the target pose rather than farther from the target pose. The loss calculator 322 can calculate a loss value to represent the difference between the currently estimated pose and the actual pose depicted in the image.

The pose evaluator 306 can continue to manipulate the model until an end state is reached. In some examples, the end state is reached when the loss value drops below a predetermined threshold. In other examples, the end state can be reached when the model manipulator has made a predetermined number of manipulations without finding any adjustments that improve the loss value. For example, if the model manipulator 320 has performed fifty fine-tuning adjustments, all of which result in a worse loss value, the pose evaluator can determine that an end state has been reached.

In some examples, the pose evaluator 306 can be part of an optimization system that enables highly specific pose estimations to be achieved. The estimated pose can be sent to the movement detector 308. The movement detector 308 may receive a series of poses for the animal as it moves over time. Using a plurality of pose estimates, the movement detector 308 can determine the movement of the animal. The diagnosis model 310 can take the estimated movement as input. Once the estimated movement has been input, the diagnosis model 310 can output information associated with the animals, including but not limited to an evaluation of the health of the animal, information about the animal's activities, and/or animal position or pose data.

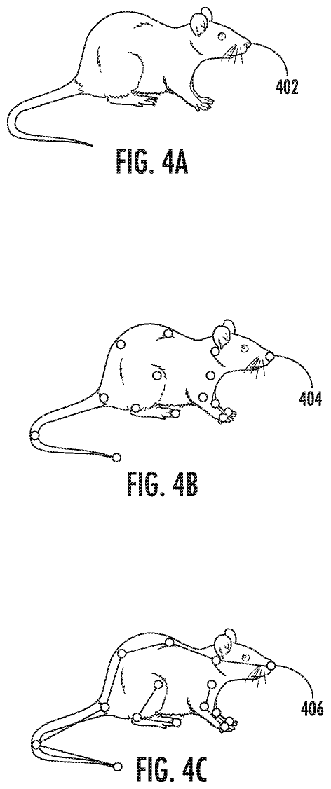

FIG. 4A depicts an image of an animal (e.g., a rat) 402 captured by an image capture system according to example embodiments of the present disclosure. FIG. 4B depicts an image of an animal (e.g., a rat) 404 that has been analyzed to identify a plurality of joint positions according to example embodiments of the present disclosure. Each dot on the image represents a joint position on the rat. The joint positions can represent points along the animal's body and limbs that can move or bend.

FIG. 4C depicts an image of an animal (e.g., a rat) 406 according to example embodiments. This example has a plurality of joint elements that are connected to one or more other join elements, the connections representing how and where the joints are connected. This data can be used to determine how the model can be manipulated for different poses. FIG. 4D depicts example three-dimensional body models according to example embodiments. A first example is a three-dimensional body model 420 associated with a particular rodent. The second example is an example of three-dimensional body model 422 of a rodent with the underlying mesh visible.

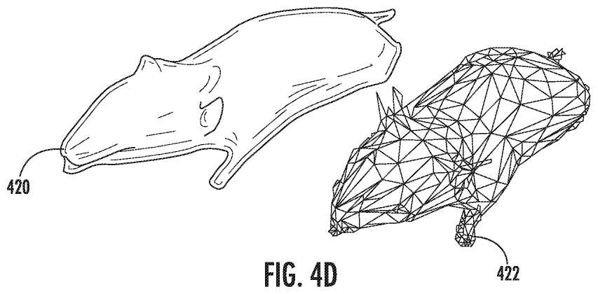

FIG. 5 depicts a block diagram of an animal monitoring system 502 according to example embodiments of the present disclosure. An animal monitoring system 502 can include an animal diagnostic model 504. The animal diagnostic model 504 can be trained to receive a set of input data (e.g. one or more images) associated with an animal, and, in response to the receiving input data, provide output data that represents an evaluation of the health of the animal. Thus, in some implementations, the animal diagnostic model 504 can be operable to provide an evaluation of the health of an animal based on a series of images of the animal.

In some examples, the animal diagnostic model 504 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

The animal diagnostic model 504 can be trained based on training data using various training or learning techniques, such as, for example, backward propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over several training iterations. In some implementations, performing backward propagation of errors can include performing truncated backpropagation through time. Generalization techniques (e.g., weight decays, dropouts, etc.) can be performed to improve the generalization capability of the models being trained.

The animal diagnostic model 504 may be a multi-step model for generating a diagnosis of animals based on image data according to example embodiments of the present disclosure.

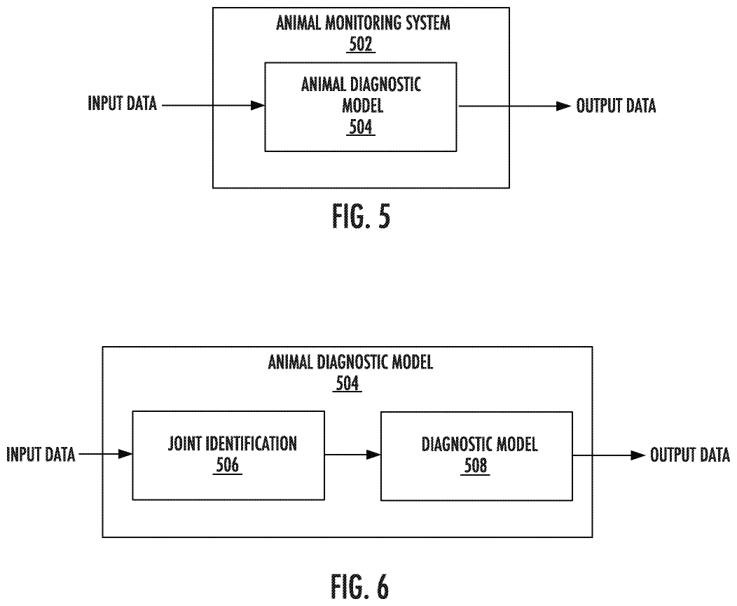

FIG. 6 depicts a block diagram of a multi-step model for generating diagnoses for animals according to example embodiments of the present disclosure. The animal diagnosis model is similar to the model depicted in FIG. 5 except that the model includes a joint identification model 506 and a diagnosis model 508. The joint identification model 506 can identify the position of one or more joints for an animal based on each of one or more input images. The diagnosis model 508 can generate a diagnosis based on one or more estimated poses.

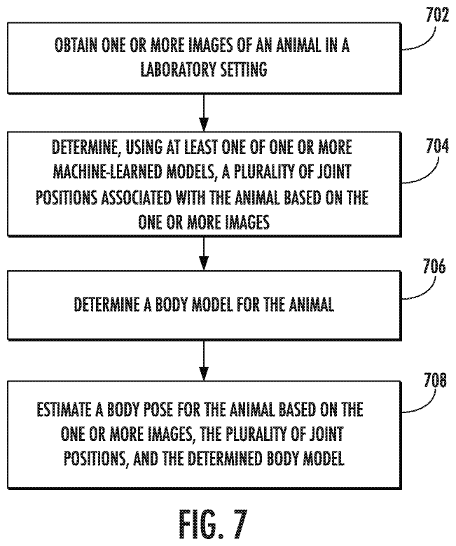

FIG. 7 depicts a flow chart of an example method for monitoring animals using image data according to example embodiments of the present disclosure. To perform the method, a monitoring system obtains, at 702, one or more images of an animal. The monitoring system determines, at 704, using at least one or more machine-learned models, a plurality of joint positions associated with the animal based on the one or more images. In some examples, the plurality of joint positions can comprise a two-dimensional pose estimate for the animal.

The monitoring system determines, at 706, a body model for the animal. In some examples, the body model can comprise a three-dimensional body model for the animal. The body model for the animal is determined based on a stored repository of animal body data. The monitoring system estimates, at 708, a body pose for the animal based on the one or more images, the plurality of joint positions, and the determined body model. In some examples, a body pose for the animal can comprise a three-dimensional body pose.

In some examples, the monitoring system places the body model in an initial body pose, wherein the body model includes a plurality of adjustable points and the initial pose is a predetermined neutral pose. The monitoring system can perform one or more adjustments of one or more of the adjustable points based on the body model, wherein each adjustment causes a change from the initial body pose to a current body pose. After each adjustment, the monitoring system can determine a loss score associated with the current body pose. In accordance with a determination that one or more criteria have been met, the monitoring system determines that the current pose is the estimated body pose. Thus, if the criteria have been met, the monitoring system ceases to manipulate the body model and uses the current model as the estimated mode for the animal.

In some examples, the criteria can be a threshold loss value, and the monitoring system can determine that a criterion is met when the calculated loss value is below the predetermined threshold value. In some examples, determining whether the criteria is met comprises determining whether any additional adjustments result in a lower loss value. In some examples, the loss score comprises a joint position similarity score and a silhouette similarity score. The joint position similarity score can have a first weight and the silhouette similarity score can have a second weight and the first weight and the second weight can be determined, at least in part, based on a species associated with the animal.

In some examples, the joint position similarity score represents a difference between one or more projected joint positions in a projection of the current body pose onto a two-dimensional image and the one or more joint positions determined from the one or more images. In some examples, the silhouette similarity score represents a difference between a silhouette of a two-dimensional projection of the current body pose and an original silhouette determined from the one or more images

The monitoring system can estimate a series of body poses for the animal, each body pose corresponding to an image in the sequence of images captured over time. The monitoring system can determine a pattern of movement for the animal during the period of time based on the series of body poses for the animal.

The monitoring system can generate a health evaluation for the animal based on the series of body poses for the animal. In some examples, generating a health evaluation comprises generating diagnostic data for the animal that provides a diagnosis for the animal. In another example, generating a health evaluation can comprise detecting one or more abnormal behaviors exhibited by the animal

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

1. A computer-implemented method for determining poses of animals from imagery comprising:
obtaining, by a computing system, one or more images of an animal;
determining, by the computing system and using at least one of one or more machine-learned models, a plurality of joint positions associated with the animal based on the one or more images;
determining, by the computing system, a body model for the animal; and
estimating, by the computing system, a body pose for the animal based on the one or more images, the plurality of joint positions, and the determined body model.

2. The computer-implemented method of claim 1, wherein the one or more images include sequence of images captured over a period of time, the method further comprising:
estimating, by the computing system, a series of body poses for the animal, each body pose corresponding to an image in the sequence of images captured over time.

3. The computer-implemented method of claim 2, the method further comprising:
determining, by the computing system, a pattern of movement for the animal during the period of time based on the series of body poses for the animal.

4. The computer-implemented method of claim 2, the method further comprising:
generating, by the computing system, a health evaluation for the animal based on the series of body poses for the animal.

5. The computer-implemented method of claim 4, wherein:
generating, by the computing system, the health evaluation comprises generating, by the computing system, diagnostic data for the animal that provides a diagnosis for the animal.

6. The computer-implemented method of claim 4, wherein:
generating, by the computing system, the health evaluation comprises detecting, by the computing system, one or more abnormal behaviors exhibited by the animal.

7. The computer-implemented method of claim 1, wherein:
the plurality of joint positions comprise a two-dimensional pose estimate for the animal;
the body model comprises a three-dimensional body model for the animal; and
the body pose for the animal comprises a three-dimensional body pose.

8. The computer-implemented method of claim 1, wherein the animal in the comprises a rodent.

9. The computer-implemented method of claim 1, wherein the one or more images are generated by a single camera.

10. The computer-implemented method of claim 1, wherein the body model for the animal is determined based on a stored repository of animal body data.

11. The computer-implemented method of claim 1, wherein estimating the body pose for the animal further comprises:
placing, by the computing system, the body model in an initial body pose, wherein the body model includes a plurality of adjustable points and the initial body pose is a predetermined neutral pose.

12. The computer-implemented method of claim 11, wherein estimating the body pose for the animal further comprises:
performing, by the computing system, one or more adjustments of one or more of the adjustable points based on the body model, wherein each adjustment causes a change from the initial body pose to a current body pose;
after each adjustment, determining, by the computing system, a loss score associated with the current body pose; and
in response to a determination that one or more criteria has been met, determining, by the computing system, that the current body pose is the estimated body pose.

13. The computer-implemented method of claim 12, wherein determining whether the criteria is met comprises:
determining whether the loss score for the current body pose falls below a threshold loss value.

14. The computer-implemented method of claim 12, wherein determining whether the criteria is met comprises:
determining whether any additional adjustments results in a lower loss value.

15. The computer-implemented method of claim 12, wherein the loss score comprises a joint position similarity score and a silhouette similarity score.

16. The computer-implemented method of claim 15, wherein the joint position similarity score has a first weight and the silhouette similarity score has a second weight and wherein the first weight and the second weight are determined, at least in part, based on a species associated with the animal.

17. The computer-implemented method of claim 15, wherein the joint position similarity score represents a difference between one or more projected joint positions in a projection of the current body pose onto a two-dimensional image and the plurality of joint positions determined from the one or more images.

18. The computer-implemented method of claim 15, wherein the silhouette similarity score represents a difference between a silhouette of a two-dimensional projection of the current body pose and an original silhouette determined from the one or more images.

19. A system for measuring rodent health through three-dimensional pose dynamics from images, the system comprising:
one or more cameras positioned to capture images that depict a space that includes a rodent; and
a computing system comprising one or more processors and a non-transitory computer-readable memory;
wherein the non-transitory computer-readable memory stores instructions that, when executed by the processor, cause the computing system to perform operations, the operations comprising:
obtaining, by the one or more processors, one or more images of the rodent in the space;
determining, by the one or more processors and using a machine-learned model, a plurality of joint positions associated with the rodent based on the one or more images;
estimating, by the one or more processors, a body pose for the rodent based on the plurality of joint positions; and
generating, by the computing system, a health evaluation for the rodent based on the body pose for the rodent.

20. A non-transitory computer-readable medium storing instructions that, when executed by one or more computing devices, cause the one or more computing devices to perform operations, the operations comprising:
obtaining one or more images of an animal;
determining, using a machine-learned model, a plurality of joint positions associated with the animal based on the one or more images;
determining a body model for the animal, based on a stored repository of animal body data; and
estimating, using the machine-learned model, a body pose for the animal based on the one or more images, the plurality of joint positions, and the determined body model.
